(19) United States
(12) Patent Application Publication
(10) Pub. No.: US 2006/0044570 A1
(43) Pub. Date: Mar. 2, 2006

(54) Laser-based position measuring device

(75) Inventor: Volker Konetschny, Muenchen (DE)

Correspondence Address: NIXON PEABODY, LLP, 401 9TH STREET, NW, SUITE 900, WASHINGTON, DC, 20004-2128, US

(73) Assignee: Prueftechnik Dieter Busch AG, Ismaning (DE)

(21) Appl. No.: 11/210,102

(22) Filed: Aug. 24, 2005

(30) Foreign Application Priority Data
Aug. 25, 2004 (DE) 10 2004 041 278.2

(51) Int. Cl. G01B 11/14

(52) U.S. Cl. 356/614

(57) ABSTRACT

A position measuring device with a laser beam which rotates with a given constant rotary speed, a laser transmitter which is centered in a polar coordinate system present and emitting at least one rotary laser beam into an essentially horizontally lying plane, and allowing delivery of a synchronous signal with respect to a reference angle. A photosensitive position sensor is provided which delivers an electrical pulse which is identified by length in time and phase angle during illumination by the rotating laser beam, and the phase angle and length in time of these pulses constitute a measure of the angular position and the radial distance of the sensor in the indicated polar coordinate system.

### BACKGROUND OF THE INVENTION

1. Filed of Invention

The invention relates to a laser-based position measuring device.

2. Description of Related Art

Devices of the type to which the invention is directed are known under the generic term “Total Station” and are sold worldwide by well-known companies. These known devices presuppose a comparatively high investment requirement.

### SUMMARY OF THE INVENTION

An object of the invention is to device which is much more economical device than the known devices and which can be used for less stringent 2- or 3-dimensional measurement tasks. These measurement tasks are to be performed in diverse industries, for example, in measurements of flatness in machine tool construction.

This object is achieved by a device according to the features of the invention described below.

The invention is explained below using the drawings.

### BRIEF DESCRIPTION OF THE DRAWINGS

FIG. 1 is a schematic representation of a laser beam rotating in a horizontal plane,

FIG. 2 is a plot of the laser pulses,

FIG. 3 is an idealized laser pulse diagram, and

FIG. 4 depicts the image of pulsed laser light points on a sensor.

### DETAILED DESCRIPTION OF THE INVENTION

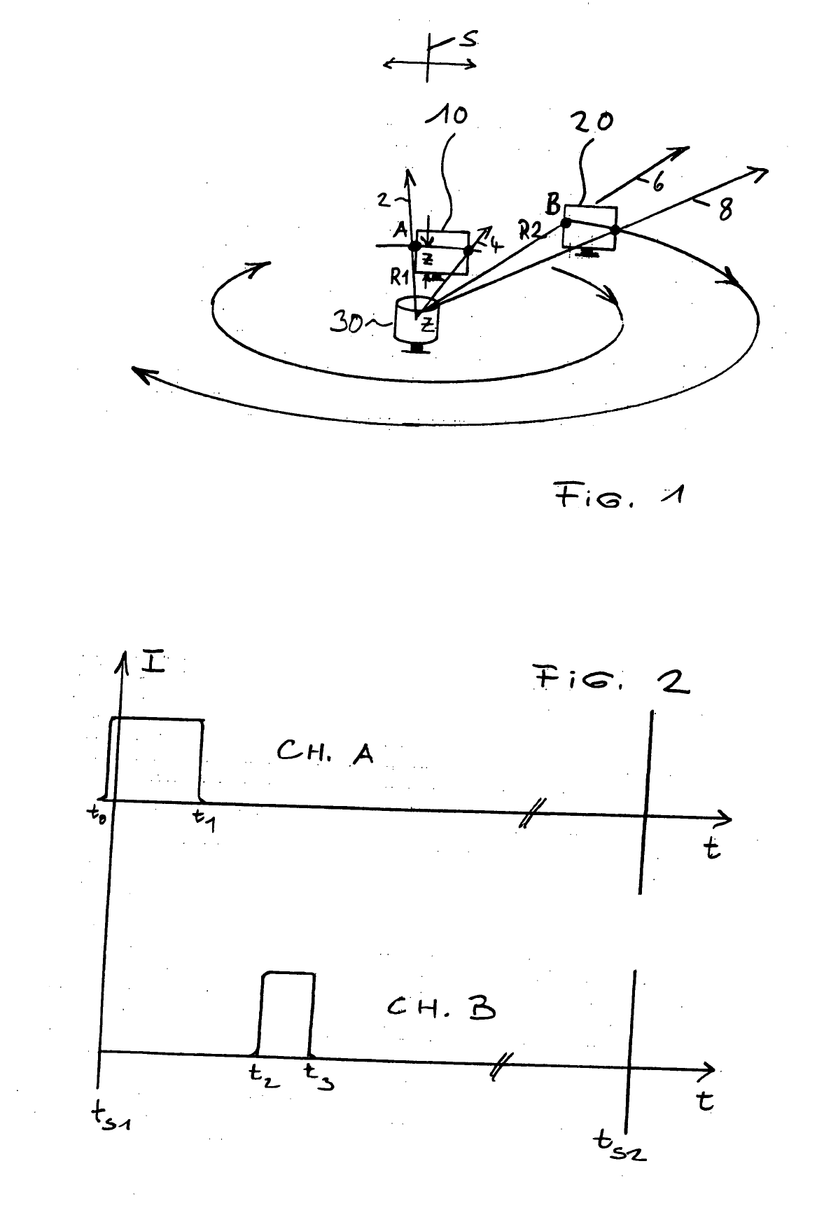

FIG. 1 schematically shows a laser beam which rotates in the horizontal plane AZB. To do this, a laser beam generator 30 is used which has a motorized means (not shown) with which a laser beam can be set into rotary motion around a center Z. In this way, the laser beam moves successively into for example positions 2, 4, 6, and 8 in the pertinent, for example, essentially horizontally lying plane which is very flat. The motorized means is made such that a very constant angular velocity of the laser can be maintained so that, for example, the deviation of the laser beam from the actual angular position relative to the theoretical angular position at any given instant is simply, for example, 10E⁻⁴ rad (100 microrad). The components of such a motorized means are known. In times which periodically recur in an exact manner, the laser beam can therefore scan a reference mark S.

To determine the x- and y-position of, for example, a graduated ruler, a measurement sensor or the like in a measurement plane which is to be checked, in accordance with the invention, for each such graduated ruler or the like, there is an optoelectronic detector (sensor) which is also preferably able to read out the site at which a light beam impinges, one-dimensionally, preferably two-dimensionally. In particular, the optoelectronic detector is relatively fast and within an extremely short time produces an output signal or an altered output signal as soon as light or additional light is incident on it.

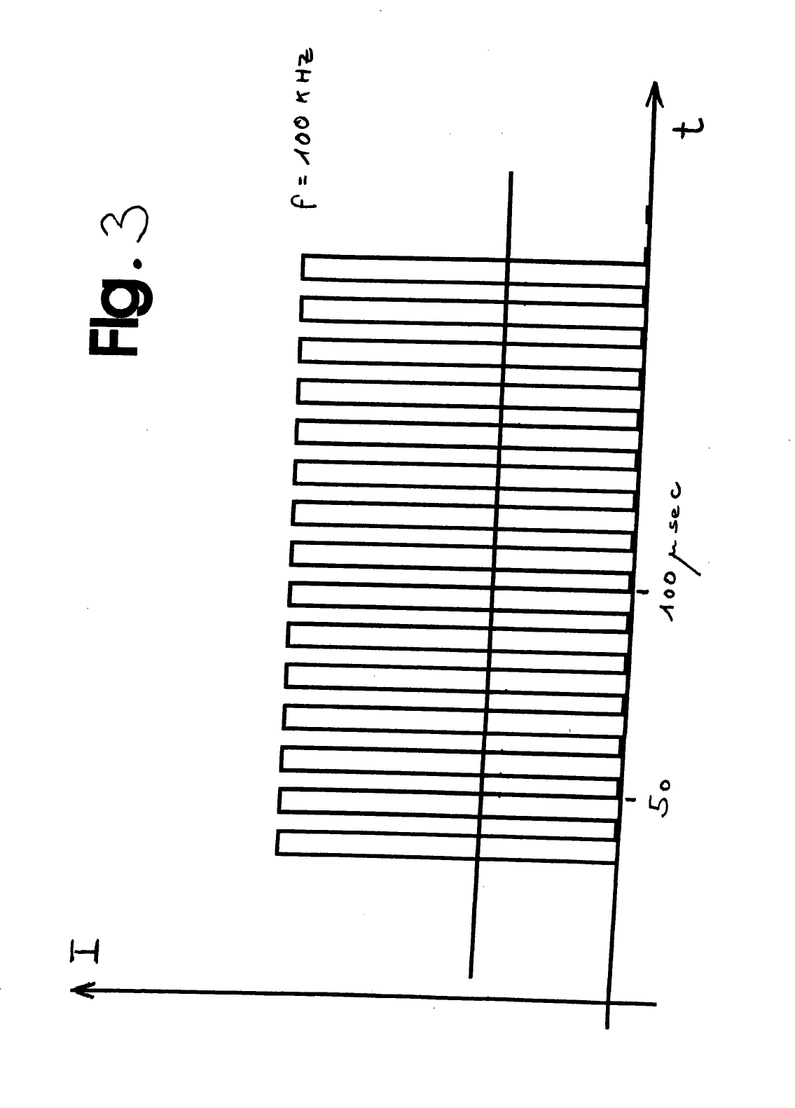

According to the invention, the determination of the aforementioned x- and y-position is accomplished in that, first a radius angle determination is carried out in polar coordinates (rho, phi) and the polar coordinates determined are then converted by electronics or a computer into an x- and y-position determination. The optoelectronic detector of the invention will therefore deliver signals which, depending on its position, have a different, but exactly defmable phase angle which is determined, for example, by the rising edge of the measured pulse relative to cyclically repeated time zero points tₛ₁ and tₛ₂ which are stipulated on the laser beam generator (compare FIG. 2). Furthermore, according to the invention, the length in time of the signals delivered by the optoelectronic detector is variable and depends essentially on the radial distance of the detector from the center Z. If provisions are made for the receiving surface of the detector to be oriented perpendicular to the incident laser beam, therefore based on the length of a pulse in time and its phase angle, the coordination of the measurement point by radius and relative angle with respect to a starting angle can be undertaken.

For example, FIG. 1 shows a detector 10 which is positioned at a radial distance R1, over which a laser beam is swung from the initial position 2 to the end position 4, at a height “z”. As long as the detector is illuminated by the laser beam, at least one signal is delivered. However, the detector is devised such that, preferably, two signals can be delivered which contain information about the impact point of the laser beam according to two coordinates. The time signal which is present during illumination of the detector 10 by the laser beam is shown in FIG. 2 over the time between the instants t₀ and t₁ as a channel A (“CH.A”).

If the same or a second detector 20 is positioned in position B with a radial distance R2, the laser beam can illuminate it between the angular positions 6 and 8, beginning from position B, which can have a ordinate value different than that in position A. The respective delivered electrical pulse is shown in FIG. 2 in the lower part as a channel B signal (“CH.B”) between the instants t₂ and t₃. The instants t₂ and t₃, therefore, in this example, are later than t₀ and t₁, the corresponding time difference of the pulse centers is therefore a measure of the angle AZB. Furthermore, the pulse widths (t₀-t₁) and (t₂-t₃) are different, due to the respectively identical measurement surface of the sensor and the different radial distances in the different measurement positions. For a fixed sensor, comparable pulses arise with each beam passage so that data from several, for example, 5 to 70 pulses, can be combined into a mean value. Such a mean value then has higher precision than only a single measurement value.

In one modified embodiment of the invention, a laser beam is used which likewise rotates uniformly, but pulsates, so that during its rotation with a frequency of, for example, 100 kHz, it is continuously turned on and off. The frequency can also be switched, for example, one revolution of the laser can take place in continuous wave operation, followed by one revolution with 100 kHz pulse frequency, then a revolution with 30 kHz, then one revolution with 10 kHz or the like, without the rotary motion being modified in any way. In this case, the sensor can therefore both detect pulse times and also can have the number of individual pulses counted by a downstream counter or computer. In this way, a measure of the time which the laser beam had required to scan the sensor from one edge to another is made available. A corresponding idealized pulse diagram is shown in FIG. 3.

With a laser pulse which has been modulated in this way, i.e., a pulsating laser pulse, it is likewise possible, instead of detectors or sensors which act over an entire surface (so-called position sensing diodes), to use those with many individual pixels if their sensing surface is dimensioned to be large enough. The pulsating laser beam then generates a string-of-pearls type pattern or strip-like pattern on the sensor which can be read out and evaluated until the next revolution. It is likewise possible to use pixel-oriented sensors of smaller dimensions if there are reducing imaging optics. In this case, it is feasible to allow the laser beam to pass over a diffusing screen of defined size, for example, 50 mm width, and to image the picture of the diffusing screen together with the laser light incident there by means of a lens of roughly 10 mm focal length onto a pixel-oriented sensor.

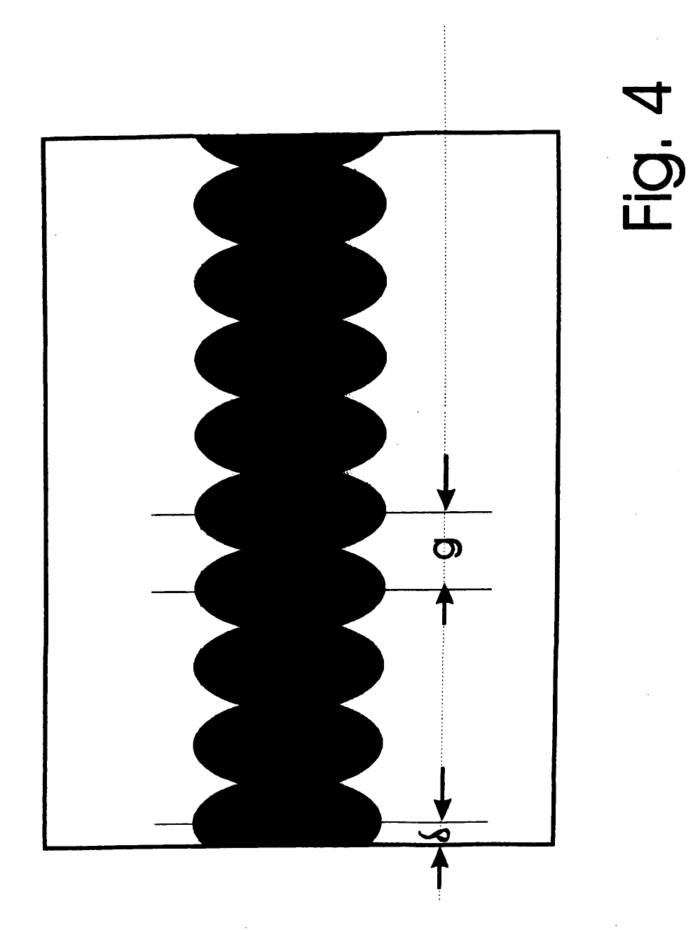

It is apparent that the number of individual laser light pulses registered by the sensor is a measure of the time which the laser had required to scan the diffusing screen. An image of the pulsed laser light points on the sensor is shown in FIG. 4. As is recognized, the lattice constant (reference letter “g” in FIG. 4) relative to the dimensions of the sensor is a measure of the radial distance of the sensor from the center Z. With this information, the precision of the measurement can be further improved. Likewise, based on the periodicity of the registered point sequence, the phase angle “delta” can be determined with relative accuracy. With this phase information, it is therefore possible to more accurately determine the edge position of the pulses, as shown, for example, in FIG. 2, and thus, the desired azimuth value of the position which is to be measured. To determine the quantities “g” and “delta” different mathematical methods can be used, for example, those of a Fourier transform, especially one which is applied to all detected pixels.

In addition to the data for its coordinates (by radius and azimuth angle), the sensor can thus simultaneously deliver a leveling value (height value or z-component) at the respective measurement position so that, with a small number of system components, an especially economical measuring device which measures in three dimensions is provided.

1-4. (canceled)

5. Position measuring device, comprising:
a rotary laser beam transmitter which is located at the center of a polar coordinate system, the rotary laser beam transmitter being rotatable about said center in a fixed plane at a given constant rotary speed, and being adapted to emit at least one rotary laser beam;
at least one photosensitive position sensor mounted in the path of said at least one rotary laser beam which delivers an electrical pulse which is representative of the length in time and phase angle during illumination thereof by the rotating laser beam; and
means for determining a measure of the angular position and the radial distance of the sensor in the indicated polar coordinate system from the phase angle and length in time of the pulses delivered by said at least one photosensitive position sensor.

6. Position measuring device as claimed in claim 5, wherein the laser transmitter delivers a pulsed laser beam for producing a pulse train comprised of a plurality of individual pulses on the at least one photosensitive position sensor.

7. Position measuring device as claimed in claim 6, wherein the photosensitive position sensor is one of a position sensing diode (PSD) and a pixel-oriented sensor of one of a CMOS and CCD construction.

8. Position measuring device as claimed in claim 5, wherein the photosensitive position sensor is one of a position sensing diode (PSD) and a pixel-oriented sensor of one of a CMOS and CCD construction.
